(19) United States
(12) Patent Application Publication
(10) Pub. No.: US 2004/0040652 A1
(43) Pub. Date: Mar. 4, 2004

(54) Methods for electrostatically adhering an article to a substrate

(75) Inventors: Vivek Bharti, West St. Paul, MN (US); Scott D. Pearson, Woodbury, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/232,259

(22) Filed: Aug. 30, 2002

(51) Int. Cl. B32B 31/00

(52) U.S. Cl. 156/273.1

(57) ABSTRACT

Methods for adhering an article having an electret charge to a substrate are disclosed. The methods include a step in which a charging material is used increase the adhesion of the article to the substrate.

### TECHNICAL FIELD

The present invention relates to methods of electrostatically adhering an article to a substrate.

### BACKGROUND

An electret is a dielectric material exhibiting a permanent or semi-permanent charge (i.e., electret charge). Electret articles (i.e., articles having an electret charge) are generally electrostatically attracted to a wide variety of substrates. If the electrostatic attraction is sufficiently strong, and the electret article and substrate are brought into intimate contact, they generally electrostatically adhere to one another. The strength of such adhesion (e.g., shear adhesion) depends in part on the electret charge density. Over time (e.g., a period of weeks, months, or years), and/or after removal and reapplication of the electret article to the substrate, the electret charge density may gradually decay, thereby reducing adhesion of the electret article to the substrate, potentially to the point of adhesive failure. Thus, performance of commercially available electret articles may vary widely depending on the elapsed time between manufacture and their ultimate use by a consumer.

It would be desirable to have a method for increasing the electrostatic adhesion of an electret article to a substrate that can be practiced immediately prior to, or during, use.

### SUMMARY

In one aspect, the present invention provides a method of adhering an article to a substrate comprising:

providing an article having a first surface and second surface opposite the first surfaces;

providing a substrate having a surface;

providing a charging material;

adhering the first surface of the article with the surface of the substrate, wherein the adhesion of the article to the substrate has a first level;

applying a restraining force to fix the position of the article relative to the substrate;

rubbing the second surface of the article with the charging material, wherein the adhesion between the article and the substrate increases to a second level that is higher than the first level; and

removing the restraining force,

wherein at least one of the article or the substrate comprises a thermoplastic polymeric material having an electret charge, and wherein the first surface of the article and the surface of the substrate are free of adhesive.

In another aspect, the present invention provides a method of adhering an article to a substrate comprising:

providing an article having a first surface and second surface opposite the first surfaces;

providing a substrate having a surface;

providing a charging material;

adhering the first surface of the article to the surface of the substrate;

contacting a film or sheet with the second surface of the article;

applying a restraining force to fix the position of the article relative to the substrate;

rubbing the film with the charging material, whereby the first surface of the article becomes firmly adhered to the surface of the substrate; and

removing the restraining force and film,

wherein at least one of the article or the substrate comprises a thermoplastic polymeric material having an electret charge.

In another aspect, the present invention provides a method of adhering an article to a substrate comprising:

providing an article having a first surface and second surface opposite the first surfaces;

providing a substrate having a surface;

providing a charging material;

adhering the first surface of the article with the surface of the substrate, wherein the adhesion of the article to the substrate has a first level;

contacting a film or sheet with the second surface of the article;

applying a restraining force to fix the position of the article relative to the substrate;

rubbing the film with the charging material, wherein the adhesion between the article and the substrate increases to a second level that is higher than the first level; and

removing the restraining force and film,

wherein at least one of the article or the substrate comprises a thermoplastic polymeric material having an electret charge, and wherein the first surface of the article and the surface of the substrate are free of adhesive.

According to the present invention, it is possible to increase adhesion between electret articles and substrates. The method has utility with regard to memo boards, scrapbooks, photo albums, and the like.

As used herein, the terms:

“electret article” means an article comprising an electret;

“slidably” means that objects in contact can be sheared relative to each other, without causing creasing and/or permanent deformation of either object; and

“firmly” means to electrostatically adhere in a non-slidable manner.

### BRIEF DESCRIPTION OF THE DRAWINGS

In this disclosure, several exemplary methods according to the present invention are illustrated. Throughout the drawings, like reference numerals are used to indicate common features or components.

FIG. 1 is a flow diagram of an exemplary method according to one embodiment of the present invention; and

FIG. 2 is a flow diagram of an exemplary method according to one embodiment of the present invention.

### DETAILED DESCRIPTION

The present invention provides methods for adhering an article to a substrate.

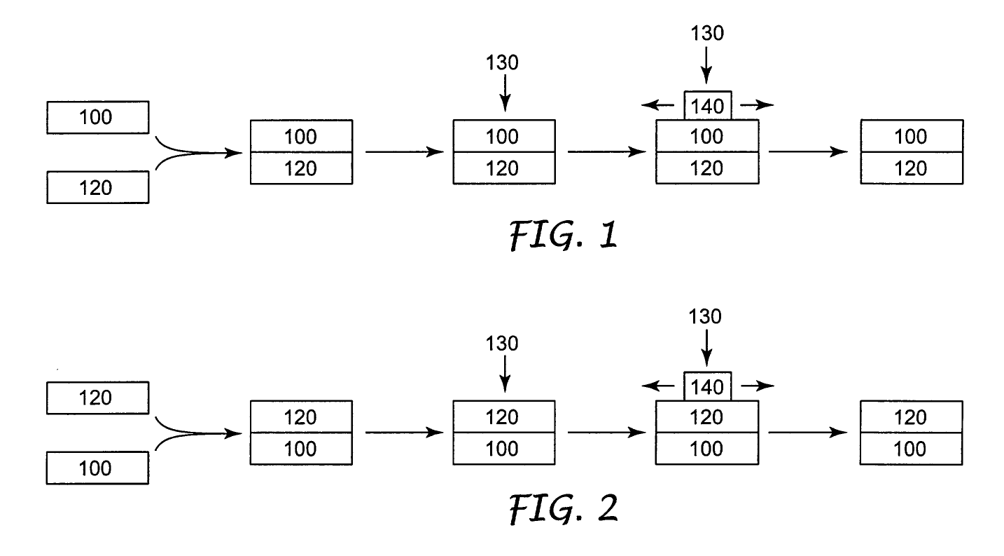

Referring now to FIG. 1, in an exemplary embodiment of the present invention, article 100 is contacted with substrate 120, whereby article 100 becomes adhered to substrate 120 with a first level of adhesion. In this embodiment of the present invention, at least one of article 100 or substrate 120 comprises a thermoplastic polymeric material having an electret charge. Restraining force 130 is applied to hold article 100 in fixed position relative to substrate 120. Subsequently, article 100 is rubbed with charging material 140. Subsequently, charging material 140 and restraining force 130 are removed, resulting in article 100 being adhered to substrate 120 with a second level of adhesion that is higher than the first level of adhesion.

Another exemplary embodiment of the invention is illustrated in FIG. 2. Referring now to FIG. 2, substrate 120 is contacted with article 100, whereby article 100 becomes adhered to substrate 120 with a first level of adhesion. In this embodiment of the present invention, at least one of article 100 or substrate 120 comprises a thermoplastic polymeric material having an electret charge. Restraining force 130 is applied to hold substrate 120 in fixed position relative to article 100. Subsequently, substrate 120 is rubbed with charging material 140. Subsequently, charging material 140 and restraining force 130 are removed, resulting in substrate 120 being adhered to article 100 with a second level of adhesion that is higher than the first level of adhesion.

Article 100 and substrate 120 may be of any size and/or form, however at least one of article 100 or substrate 120 comprises a thermoplastic polymeric material having an electret charge. Preferably, article 100 and substrate 120 are selected such that they comprise different materials. In some embodiments of the present invention (e.g., the embodiment illustrated in FIG. 2), the thickness of substrate 120 is preferably in a range of from about 10 micrometers to about 1 cm, preferably in a range of from about 10 micrometers to about 500 micrometers, more preferably in a range of from about 20 micrometers to about 100 micrometers, although other thicknesses may also be used.

Optionally, for example, in order to prevent damage to article 100 and/or substrate 120, and/or to facilitate rubbing, one or more films and/or sheets of dielectric material (e.g., a polymeric film (including polyester film, polyolefin film, polyamide film, ionomer film, or a blend or laminate thereof), a nonwoven sheet, sheet of paper) may be placed between charging material 140 and article 100 or substrate 120 prior to rubbing. Such films and/or sheets of dielectric material are preferably held in place by restraining force 130, although this is not required. Such film(s) and/or sheet(s), if present, may be the same or different from article 100 and/or substrate 120, and may be transparent or opaque. Typically, such films and/or sheets, if present, have a thickness in the range of from about 10 micrometers to about 500 micrometers, preferably in the range of from about 25 micrometers to about 100 micrometers, although other film thicknesses can be utilized.

Restraining force 130 is typically used to fix the position of article 100 relative to substrate 120. Restraining force 130 may be applied from any direction(s) as long as it serves to fix the position of article 100 relative to substrate 120. Preferably, restraining force 130 is substantially perpendicular to the surface of substrate 120. Useful methods for fixing article 100 in position relative to substrate 120 are well known in the art, and include, for example, hand pressure, removable tape, clips, clamps, and combinations of the forgoing. Hand pressure is a desirable and convenient restraining force. Restraining force 130 may also optionally serve to fix the position of any optional protective film and/or sheet of dielectric material that may be utilized, for example, as described hereinabove. As used herein, the term “fix” includes minor relative motion (e.g., less than about 1 centimeter) that may occur between article 100 and substrate 120, for example, during rubbing. Such minor relative motion is acceptable, but preferably avoided.

Article 100 and/or substrate 120, and/or any protective film(s) and/or sheet(s) that may be present, may be rubbed using any positive amount of contact pressure, preferably in a manner such that the article is not visibly damaged. Generally, light to moderate hand pressure is sufficient to rapidly increase adhesion of the article to the substrate. Rubbing of the article with the charging material may be accomplished using a linear, oscillatory, rotary, or other type of motion, and is preferably continued and/or repeated at least until the article can no longer be slid (e.g., by hand) relative to the substrate without damage to at least one of the article or the substrate. Continued rubbing typically results in higher levels of adhesion between the article and the substrate. Once rubbing is completed, any protective film(s) and/or sheet(s) that is optionally present, are typically removed (e.g., by peeling).

The charging material may comprise any solid material, and may have any form such as, for example, a nonwoven material (including spunbond or blown microfiber cloths), a woven material (e.g., a cloth), a thermoplastic polymer film, or a brush (e.g., a synthetic polymer bristle brush, an eraser). Preferably, the charging material is soft and/or flexible. Preferably, the charging material comprises a fibrous material, more preferably a nonwoven material (e.g., comprising a thermoplastic polymeric material), more preferably the charging material comprises a polypropylene spunbond.

Any solid substrate 120 may be used in practicing the present invention. The substrate may be conductive or nonconductive. Suitable substrates 120 may have vertical and/or horizontal surfaces, and may be painted or unpainted. Exemplary substrates 120 include films (e.g., thermoplastic polymer film) and film laminates (including multilayer optical films as described in, for example, U.S. Pat. Nos. 5,825,543 (Ouderkirk et al.) and 5,783,120 (Ouderkirk et al.), the disclosures of which are incorporated by reference), sheets (e.g., of paper, cardboard, coated paper), molded articles (e.g., plastic hooks), cards (e.g., greeting cards, note cards), dry erase boards, memo boards, wood, books (e.g., scrapbook, photo album), architectural surfaces (e.g., floors, walls, ceilings), glass (e.g., windows, mirrors), metal, drywall, plaster, motor vehicles (e.g., automobiles, trucks, motorcycles), trailers (e.g., truck trailers), mobile homes, boats, furniture (e.g., wicker furniture), boxes, cabinets, mats, wall hangings, doors, dishes (e.g., glasses, plates, and ceramic dishes), ceramic tile, photographs, banners, balloons, signs, paper, and cloth. Preferably, substrate 120 comprises a film or sheet, preferably comprising a thermoplastic polymer or paper. Preferably, substrate 120 is non-conductive (i.e., a dielectric), although this is not a requirement.

Preferably, substrate 120 has at least one, more preferably at least two, major surfaces (e.g., two opposed major surfaces), at least one of which major surfaces preferably has at least portion thereof that is substantially planar. As used herein, the term “substantially planar” encompasses surfaces that are generally planar in appearance, optionally having minor irregularities, imperfections and/or warpage.

Preferably, substrate 120 and/or article 100, are chosen such that rubbing the two together results in tribocharging. Surfaces of substrate 120 and/or article 100 may be rough and/or smooth. Substrate 120 and/or article 100 may be rigid, semi-rigid, or flexible. To further maximize intimate adhesion between article 100 and substrate 120, at least one of article 100 and substrate 120 is preferably chosen such that it is flexible and/or conformable, however this is not a requirement. In some embodiments of the present invention (e.g., if article 100 and/or substrate 120 is flexible), substrate 120 and/or article 100 may be contacted with a rigid support during rubbing with charging material 140. While not a requirement, it is desirable that at least a portion of the surface of substrate 120 and/or article 100 (i.e., the region of the surface where they contact each other) is smooth and/or planar.

Optionally, while contacting article 100 and substrate 120, it may be desirable to smooth out wrinkles in article 100 and/or substrate 120 (e.g., by hand), and/or slide article 100 along the surface of the substrate 120 to properly align it.

Typically, increases in adhesion (e.g., shear adhesion and/or peel adhesion) between article 100 and substrate 120, achieved by methods according to the present invention, may be reduced in magnitude, if surfaces of article 100 and/or substrate 120 that contact one another have loose fibers or filaments extending from the surface. Thus, it is preferable that surfaces of the article 100 and substrate 120 that contact one another do not have loose fibers or filaments extending therefrom.

Surfaces of article 100 and substrate 120 that contact one another may be contaminated by particulate matter (e.g., dust), but are preferably substantially free of such contamination. Methods for removing such contaminants are well known in the art.

To facilitate removability of article 100 from substrate 120 (e.g., if repositioning article 100) and to greatly reduce the possibility of adhesive residue and/or substrate damage, contacting surfaces of electret articles and substrates of the present invention are free from adhesive (including removable adhesive and latent adhesive) materials as disclosed in, for example, U.S. Patent Publication No. 2002/009059 (Hsu et al.), published Jul. 11, 2002, the disclosure of which is incorporated herein by reference.

At least one of article 100 and substrate 120 typically comprises a thermoplastic polymeric material having an electret charge. Typically, the thermoplastic polymeric material should be a dielectric material in order to establish and maintain an electret charge. Exemplary useful thermoplastic polymeric materials include fluorinated polymers (e.g., polytetrafluoroethylene, polyvinylidene fluoride, tetrafluoroethylene-hexafluoropropylene copolymers, vinylidene fluoride-trifluorochloroethylene copolymers), polyolefins (e.g., polyethylene, polypropylene, poly-4-methyl-1-pentene, propylene-ethylene copolymers), copolymers of olefins and other monomers (e.g., ethylene-vinyl acetate copolymers, ethylene-acrylic acid copolymers, ethylene-maleic acid anhydride copolymers, propylene-acrylic acid copolymers, propylene-maleic acid anhydride copolymers, 4-methyl-1-pentene-acrylic acid copolymers, 4-methyl-1-pentene-maleic acid anhydride copolymers), ionomers (e.g., ethylene-(meth)acrylic acid copolymers with acidic protons replaced by Na⁺, K⁺, Ca²⁺, Mg²⁺, or Zn²⁺ cations), polyesters (e.g., polyethylene terephthalate), polyamides (e.g., nylon-6, nylon-6,6), nonplasticized polyvinyl chloride, polycarbonates, polysulfones, blends and mixtures thereof, and the like. Preferably, the thermoplastic polymeric material comprises at least one of polypropylene or a poly(ethylene-co-methacrylic acid) ionomer, more preferably a poly(ethylene-co-methacrylic acid) ionomer, more preferably a zinc poly(ethylene-co-methacrylic acid) ionomer.

Many poly(ethylene-co-(meth)acrylic acid) ionomers are commercially available as pellets and/or films, for example, as marketed under the trade designation “SURLYN” (e.g., lithium poly(ethylene-co-methacrylic acid) ionomers such as “SURLYN 7930” or “SURLYN 7940”; sodium poly(ethylene-co-methacrylic acid) ionomers such as “SURLYN 1601”, “SURLYN 8020”, “SURLYN 8120”, “SURLYN 8140”, “SURLYN 8150”, “SURLYN 8320”, “SURLYN 8527”, “SURLYN 8660”, “SURLYN 8920”, “SURLYN 8940”, or “SURLYN 8945”; zinc poly(ethylene-co-methacrylic acid) ionomers such as “SURLYN 1652”, “SURLYN 1705”, “SURLYN 1706”, SURLYN 6101“, SURLYN 9020”, “SURLYN 9120”, “SURLYN 9150”, “SURLYN 9320W”, “SURLYN 9520”, “SURLYN 9650”, “SURLYN 9720”, “SURLYN 9721”, “SURLYN 9910”, “SURLYN 9945”, “SURLYN 9950”, “SURLYN 9970”, or “SURLYN PC-100”) by E. I. du Pont de Nemours & Company, Wilmington, Delaware; or as marketed under the trade designation “IOTEK” (e.g., sodium poly(ethylene-co-acrylic acid) ionomers such as “IOTEK 3110”, “IOTEK 3800”, or “IOTEK 8000”, and zinc poly(ethylene-co-acrylic acid) ionomers such as “IOTEK 4200”) by ExxonMobil Corporation, Houston, Tex. Further details of useful poly(ethylene-co-(meth)acrylic acid) ionomers are described in, for example, commonly assigned U.S. Patent Application entitled “METHOD OF ADHERING A FILM AND ARTICLES THEREFROM” (Bharti et al.), bearing Attorney Case No. 57946US002, filed concurrently herewith, the disclosure of which is incorporated herein by reference.

The thermoplastic polymeric material may be melt-extruded (e.g., from pellets) into a film, molded into a three-dimensional form, or otherwise processed into any desired form using procedures well known in the thermoplastic materials processing art.

Optionally, one or more additives can be compounded into the thermoplastic polymeric material. Exemplary optional additives include antioxidants, ultraviolet light (i.e., UV) stabilizers, fillers (e.g., inorganic or organic), glass beads, glass bubbles, colorants (e.g., dyes, pigments), and fragrances. To allow formation of high levels of charge density, additives (e.g., antistatic agents) that can impart electrical conductivity to the thermoplastic polymeric material are preferably minimized or avoided.

Exemplary optional additives include antioxidants, light stabilizers (e.g., as available from Ciba Specialty Chemicals, Tarrytown, N.Y., under the trade designations “CHIMASSORB 2020”, “CHIMASSORB 119”, “CHIMASSORB 944”, “TINUVIN 783”, or “TINUVIN C 353”), thermal stabilizers (e.g., as available from Ciba Specialty Chemicals under the trade designations “IRGANOX 1010”, “IRGANOX 1076”), fillers (e.g., inorganic or organic), charge control agents (e.g., as described in U.S. Pat. No. 5,558,809 (Groh et al.)), fluorochemical additives (e.g., as described in U.S. Pat. Nos. 5,976,208 (Rousseau et al.) and 6,397,458 (Jones et al.)), glass beads, glass bubbles, colorants (e.g., dyes, pigments (including phosphorescent pigments), and fragrances.

Exemplary optional additives also include titanium dioxide (e.g., in particulate form). If present, the amount of titanium dioxide preferably is in a range of from about 1 to about 50 percent by volume, more preferably in a range of from about 1 to about 20 percent by volume, based on the total volume of the film, although greater and lesser amounts of titanium dioxide particles may also be used.

Electret articles (e.g., films) can be readily obtained from commercial sources or prepared by a variety of methods that are well known in the art. For details on methods for making electret films, see, for example, “Electrets”, G. M. Sessler (ed.), Springer-Verlag, New York, 1987. Exemplary methods of forming electrets are well known in the art and include thermal electret, electroelectret (e.g., DC corona discharge), radioelectret, magnetoelectret, photoelectret, and mechanical electret forming methods as described in, for example, U.S. Pat. No. 5,558,809 (Groh et al.), the disclosure of which is incorporated herein by reference. Typically, electrets utilized in practice of the present invention have an electret charge density of greater than about 0.05 nanoCoulombs per square centimeter (nC/cm²), preferably greater than about 0.5 nC/cm², more preferably greater than about 5 nC/cm². Corona charging (e.g., using direct current or alternating current as described in, for example, U.S. Pat. Nos. 6,001,299 (Kawabe et al.) and 4,623,438 (Felton et al.), the disclosures of which are incorporated herein by reference) is a desirable and convenient method for preparing electrets that are useful in practice of the present invention.

Exemplary commercially available electret films include polypropylene electret films marketed under the trade designation “CLINGZ” by Permacharge Corporation, Rio Rancho, N. Mex.

Electrets (e.g., electret films) typically have an orientation to their charge distribution. For example, one surface of an electret film may be positively charged and an opposite surface negatively charged. Surprisingly, the method of the present invention is effective regardless of orientation of charges in the electret, whether it be in article 100 or substrate 120. Accordingly, the methods of the present invention have broad applicability for static cling. In particular, methods of the present invention are useful for adhering papers, cards, and photographs to pages in scrapbooks or to memo boards. They are also useful for adhering films to walls to which additional articles can subsequently be adhered.

In one embodiment of the present invention, article 100 may comprise an electret film having an image on a major surface thereof (i.e., a template). In this embodiment, the template is typically adhered to the substrate such that image is exposed. Adhesion of the template to the substrate is typically sufficiently strong that it is possible to successfully drill or otherwise punch through the template into the substrate without the template being substantially otherwise disturbed. Afterwards, the template may be easily removed by peeling from the substrate, without leaving residue (e.g., adhesive residue).

The present invention will be more fully understood with reference to the following non-limiting examples in which all parts, percentages, ratios, and so forth, are by weight unless otherwise indicated.

### EXAMPLES

In the following examples, ambient conditions were temperatures in a range of from 21° C. to 23° C., with relative humidity in a range of from 10 percent to 70 percent.

The following abbreviations are used throughout the examples that follow:

| | |
|---|---|
| FILM A | Zinc polyethylene-methacrylic acid ionomer pellets (78 parts |
| | obtained under the trade designation “SURLYN 1705-1” from E. |
| | I. du Pont de Nemours & Company, Wilmington, Delaware), |
| | and 22 parts of a mixture of 15.4 parts titanium dioxide |
| | dispersed in 6.6 parts polyethylene (obtained under the trade |
| | designation “STANDRIDGE 11937 WHITE CONCENTRATE” |
| | from Standridge Color, Bridgewater, New Jersey) were |
| | combined and extruded onto a polyester liner (2 mils (50 |
| | micrometers) thickness) using a 2.5 inch (6.4 cm) single screw |
| | extruder (model number: 2.5TMIII-30, obtained from HPM |
| | Corporation, Mount Gilead, Ohio), at a temperature of 199° C., |
| | resulting in a film (FILM A) having a thickness of 3 mils |
| | (80 micrometers) adhered to a polyester liner (2 mils |
| | (50 micrometers) thickness). |
| FILM B | FILM A was stripped from its associated liner and corona |
| | charged by passing the film, while in contact with an aluminum |
| | ground plane, through a direct current (i.e., DC) corona charger |
| | equipped with a series of stainless steel wires at a voltage of +19 |
| | kilovolts. The wires were positioned at a distance of 1 inch (2.5 |
| | cm) from the ground plane, and were spaced such that the |
| | corona discharge was continuous. The film was exposed to |
| | the corona discharge for 34 seconds. The corona charged film |
| | was contacted with the polyester liner and the film and liner |
| | were rolled onto a take up roll and stored under ambient |
| | conditions for approximately 1 year. Pieces of the film |
| | were stripped from the liner immediately prior to use. |
| FILM C | 2.2 mils (56 micrometers) thickness polypropylene film |
| | (obtained under the trade designation “CLINGZ” from |
| | Permacharge Corporation, Rio Rancho, New Mexico. |
| FILM D | 2.0 mils (50 micrometers) thickness polyethylene terephthalate |
| | film. |
| PAPER | Copier paper having the trade designation “LASER PRINT 24 |
| 1 | LB. PAPER”, 21.6 centimeters (cm) by 27.9 cm, was obtained |
| | from the Hammermill Division of International Paper, Memphis, |
| | Tennessee. |
| PAPER | Inkjet photo paper was obtained under the trade designation “HP |
| 2 | PREMIUM PHOTO PAPER GLOSSY” from Hewlett Packard |
| | Corporation, Palo Alto, California. |

Charging Methods

The following charging methods were used in the following examples:

Charging Method 1: A first piece of film (bottom layer) to be charged was held in fixed position against a laboratory bench top, by hand while a second, identically prepared, piece of film (top layer) was placed flat against the first piece of film. The second film was slid back and forth across the entire surface, by hand, against the first piece of film, using moderate pressure, across the length of the first piece ten times.

Charging Method 2: A first piece of film (top layer) was superimposed onto a second, identically prepared, piece of film (bottom layer) to form a two-layer stack and both films were held, in fixed position relative to each other, against a laboratory bench top. The top layer was stroked ten times by hand over the entire surface, using moderate pressure, across the length of the top layer using a marker board eraser having the trade designation “GHOSTDUSTER MARKER BOARD ERASER” obtained from the Quartet Company, Skokie, Ill. The eraser had a layer of exposed nonwoven web that was used to stroke the film.

Charging Method 3: The poster board, film strips, and paper were held in fixed relative position against a laboratory bench top by application of hand pressure. The piece of paper was stroked rapidly over the film strips for ten seconds, using moderate pressure, across the length of the paper using a marker board eraser having the trade designation “GHOSTDUSTER MARKER BOARD ERASER” obtained from the Quartet Company.

### EXAMPLES 1-4 and COMPARATIVE EXAMPLES A-D

The electrostatic charge of films was determined by measuring the surface potential of the film using an electrostatic voltmeter (Model No. 279, obtained from Monroe Electronics, New York, N.Y.). Surface potentials of film pieces (2 inches×4 inches (5 cm×10 cm) in dimension) were measured of the untreated film (initial condition), after laying the film flat on an identical film piece (two-layer stack), and after charging the two-layer stack (charged two-layer stack). In each case, the surface potential was measured at six different spots on the film piece, and the results were averaged.

Average surface potential measurements are reported in Table 1 (below).

TABLE 1

| SURFACE POTENTIAL, Volts | | | | | | | |
|---|---|---|---|---|---|---|---|
| | | | | | | CHARGED | |
| | | | | TWO- | TWO- | NET | |
| | | CHARGING | TOP | BOTTOM | LAYER | LAYER | INCREASE |
| EXAMPLE | FILM | METHOD | LAYER | LAYER | STACK | STACK | Volts |
| Comparative | FILM | 1 | 43 | 53 | 70 | 106 | 36 |
| Example A | A | | | | | | |
| Comparative | FILM | 1 | 17 | 49 | 47 | 185 | 138 |
| Example B | A | | | | | | |
| Comparative | FILM | 2 | 22 | 34 | 60 | 962 | 902 |
| Example C | A | | | | | | |
| Comparative | FILM | 2 | 48 | 35 | 90 | 866 | 776 |
| Example D | A | | | | | | |
| 1 | FILM | 1 | 602 | 315 | 797 | 913 | 116 |
| | B | | | | | | |
| 2 | FILM | 1 | 625 | 422 | 802 | 898 | 96 |
| | B | | | | | | |
| 3 | FILM | 2 | 581 | 715 | 912 | 2111 | 1199 |
| | B | | | | | | |
| 4 | FILM | 2 | 1047 | 1350 | 2240 | 3503 | 1263 |
| | B | | | | | | |

### EXAMPLES 5-10 and COMPARATIVE EXAMPLES E-J

Shear adhesion of FILM A or FILM B, charged according to Charging Method 1 or Charging Method 2, respectively, was determined by measuring the force necessary to slide a 2 inches×4 inches (5 cm×10 cm) piece of the film that had been lightly applied to an unpainted basswood panel (that had been sanded smooth with 240 grit sandpaper and wiped free of dust), and lightly smoothed by hand to remove wrinkles. The panel and film assembly was vertically oriented such that the 5 cm edges of the film were positioned at the top and bottom of the film. A piece of tape (¾ inch (1.9 cm) width, obtained under the trade designation “SCOTCH MAGIC TRANSPARENT TAPE” from 3M Company, St. Paul, Minn.) was vertically adhered to the top edge of the film and fastened to a cross-head of a tensile testing machine (obtained under the trade designation “SINTECH 200/S” from MTS Systems Corporation, Cary, N.C.), such that force was applied parallel to the 10 cm edges of the film piece. The force necessary to cause movement for the film relative to the panel (shear adhesion) was determined using a cross-head speed of 1 inch/minute (2.5 cm/min).

Results of shear adhesion measurements are reported in Table 2 (below).

TABLE 2

| | | | SHEAR ADHESION, | |
|---|---|---|---|---|
| | | CHARGING | g/2 inches (g/5.2 cm) | |
| EXAMPLE | FILM | METHOD | INITIAL | CHARGED |
| Comparative | FILM A | 1 | 24.6 | 24.6 |
| Example E | | | | |
| Comparative | FILM A | 1 | 24.6 | 24.6 |
| Example F | | | | |
| Comparative | FILM A | 1 | 23.6 | 23.8 |
| Example G | | | | |
| Comparative | FILM A | 2 | 24.6 | 109 |
| Example H | | | | |
| Comparative | FILM A | 2 | 24.6 | 106 |
| Example I | | | | |
| Comparative | FILM A | 2 | 23.6 | 96.8 |
| Example J | | | | |
| 5 | FILM B | 1 | 96.7 | 62.0 |
| 6 | FILM B | 1 | 80.4 | 35.9 |
| 7 | FILM B | 1 | 90.1 | 48.5 |
| 8 | FILM B | 2 | 72.4 | 299 |
| 9 | FILM B | 2 | 84.6 | 338 |
| 10 | FILM B | 2 | 96.7 | 340 |

### EXAMPLES 11-14 and COMPARATIVE EXAMPLES K-R

Two strips of the film to be tested (1.0 inch×5.0 inch (2.5 cm×12.7 cm)) were laid flat in parallel fashion onto a foam core poster board (obtained under the trade designation “STURDY BOARD” (50.8 cm×76.2 cm×5 millimeters) from Hunt Corporation, Philadelphia, Pa.) at a spacing of 4.5 inches (11.4 cm) such that the narrow ends of such strip were evenly aligned with narrow ends of the other. An 8.5 inches×5.5 inches (21.6 cm×14.0 cm) piece of paper (of indicated type) was laid onto the poster board and mounted strips, and gently smoothed out by hand, such that: each end of each strip was at a distance of 0.25 inch (0.64 cm) from an 8.5 inches (21.6 cm) side of the piece of paper, and a long edge of each film strip was at a distance of one inch from a 5.5 inch (21.6 cm) side of the piece of paper. Charging of the construction (using Charging Method 3), if utilized in the test, was performed at this point. The poster board was positioned vertically such that the piece of paper was also vertically oriented along its length. The entire assembly was allowed to stand in a laboratory at ambient temperature and humidity. The time elapsed until the paper moved more than 1 cm from its original position was recorded.

TABLE 3

| | | | | NUMBER | MEDIAN |
|---|---|---|---|---|---|
| | | | | OF | TIME TO |
| | FILM | | CHARGING | REPETI- | SHIFT, |
| EXAMPLE | STRIPS | PAPER | METHOD | TIONS | hours |
| Comparative | none | PAPER | 3 | 4 | 194.2 |
| Example K | | 1 | | | |
| Comparative | none | PAPER | 3 | 5 | 77.2 |
| Example L | | 2 | | | |
| Comparative | none | PAPER | none | 3 | <0.1 |
| Example M | | 1 | | | |
| Comparative | none | PAPER | none | 3 | <0.1 |
| Example N | | 2 | | | |
| Comparative | FILM B | PAPER | none | 3 | >1845 |
| Example O | | 1 | | | |
| Comparative | FILM B | PAPER | none | 3 | <0.1 |
| Example P | | 2 | | | |
| Example 11 | FILM B | PAPER | 3 | 3 | >1850 |
| | | 1 | | | |
| Example 12 | FILM B | PAPER | 3 | 4 | >1870 |
| | | 2 | | | |
| Comparative | FILM C | PAPER | none | 3 | <0.1 |
| Example Q | | 1 | | | |
| Comparative | FILM C | PAPER | none | 3 | <0.1 |
| Example R | | 2 | | | |
| Example 13 | FILM C | PAPER | 3 | 2 | >1850 |
| | | I | | | |
| Example 14 | FILM C | PAPER | 3 | 3 | 92.4 |
| | | 2 | | | |

Various modifications and alterations of this invention will become apparent to those skilled in the art without departing from the scope and spirit of this invention, and it should be understood that this invention is not to be unduly limited to the illustrated embodiments set forth herein.

What is claimed is:

1. A method of adhering an article to a substrate comprising:
providing an article having a first surface and second surface opposite the first surfaces;
providing a substrate having a surface;
providing a charging material;
adhering the first surface of the article with the surface of the substrate, wherein the adhesion of the article to the substrate has a first level;
applying a restraining force to fix the position of the article relative to the substrate;
rubbing the second surface of the article with the charging material, wherein the adhesion between the article and the substrate increases to a second level that is higher than the first level; and
removing the restraining force,
wherein at least one of the article or the substrate comprises a thermoplastic polymeric material having an electret charge, and wherein the first surface of the article and the surface of the substrate are free of adhesive.

2. The method of claim 1, wherein adhering comprises slidably adhering.

3. The method of claim 1, wherein the second level of adhesion is sufficient to firmly and removably adhere the article to the substrate.

4. The method of claim 1, wherein the surface of the substrate and the first surface of the article are substantially planar.

5. The method of claim 1, wherein the substrate is rigid.

6. The method of claim 1, wherein the article comprises a film.

7. The method of claim 1, wherein at least one of the article or the substrate comprises at least one of polypropylene or a poly(ethylene-co-methacrylic acid) ionomer.

8. The method of claim 3, wherein the poly(ethylene-co-methacrylic acid) ionomer comprises a zinc poly(ethylene-co-methacrylic acid) ionomer.

9. The method of claim 1, wherein either the article or the substrate comprises paper.

10. The method of claim 1, wherein the substrate is selected from the group consisting of a wall, a window, a household appliance, a door, an automobile, a memo board, a scrapbook, and a photo album.

11. The method of claim 1, wherein the article comprises paper.

12. The method of claim 1, wherein the article comprises a graphic article.

13. The method of claim 1, wherein the article has a template image on the second surface thereof.

14. The method of claim 11, further comprising drilling or punching through the template into the substrate.

15. The method of claim 1, wherein the article comprises a photograph.

16. The method of claim 1, wherein the charging material comprises at least one of a thermoplastic polymeric film, nonwoven material, a woven material, or a brush.

17. The method of claim 1, wherein the nonwoven material comprises polypropylene spunbond.

18. A method of adhering an article to a substrate comprising:
providing an article having a first surface and second surface opposite the first surfaces;
providing a substrate having a surface;
providing a charging material;
adhering the first surface of the article with the surface of the substrate, wherein the adhesion of the article to the substrate has a first level;
contacting a film or sheet with the second surface of the article;
applying a restraining force to fix the position of the article relative to the substrate;
rubbing the film or sheet with the charging material, wherein the adhesion between the article and the substrate increases to a second level that is higher than the first level; and
removing the restraining force and film or sheet,
wherein at least one of the article or the substrate comprises a thermoplastic polymeric material having an electret charge, and wherein the first surface of the article and the surface of the substrate are free of adhesive.

19. The method of claim 18, wherein adhering comprises slidably adhering.

20. The method of claim 18, wherein the second level of adhesion is sufficient to firmly and removably adhere the article to the substrate.

21. The method of claim 18, wherein the sheet comprises paper or a thermoplastic polymer.

22. The method of claim 18, wherein the film comprises a transparent thermoplastic polymer.

23. The method of claim 18, wherein the film comprises polyester.

24. The method of claim 18, further comprising removing the film or sheet from the second surface of the article.

25. The method of claim 18, wherein the surface of the substrate and the first surface of the article are substantially planar.

26. The method of claim 18, wherein the article comprises a film.

27. The method of claim 18, wherein at least one of the article or the substrate comprises at least one of polypropylene or a poly(ethylene-co-methacrylic acid) ionomer.

29. The method of claim 27, wherein the poly(ethylene-co-methacrylic acid) ionomer comprises a zinc poly(ethylene-co-methacrylic acid) ionomer.

30. The method of claim 18, wherein the substrate is selected from the group consisting of a wall, a window, an appliance, a door, an automobile, a memo board, a scrapbook, and a photo album.

31. The method of claim 18, wherein the article comprises a graphic article.

32. The method of claim 18, wherein the article comprises a photograph.

33. The method of claim 18, wherein the charging material comprises at least one of a thermoplastic polymeric film, nonwoven material, a woven material, or a brush.

34. The method of claim 18, wherein the nonwoven material comprises polypropylene spunbond.
